(19) United States
(12) Patent Application Publication
(10) Pub. No.: US 2011/0192770 A1
(43) Pub. Date: Aug. 11, 2011

(54) Method and device for sorting mail

(75) Inventors: Peter Goertz, Heinberg (DE); Bernhard Kehrbaum, Bonn (DE); Heinz-Jürgen Keen, Asbach (DE); Jochen Gülck, Frondenberg (DE); Mathias Sens, Darmstadt (DE); Dietmar Doll, Plaidt (DE)

(73) Assignee: Deutsche Post AG, Bonn (DE)

(21) Appl. No.: 11/658,243

(22) PCT Filed: Jul. 15, 2005
(86) PCT No.: PCT/EP05/07732

§ 371 Date: Jan. 23, 2009

(30) Foreign Application Priority Data
Jul. 21, 2004 (DE) 10 2004 035 365.4

(51) Int. Cl. B07C 3/00

(52) U.S. Cl. 209/592; 209/509

(57) ABSTRACT

The invention relates to a method for sorting mail and, in particular, to the route order sorting thereof. The method is characterized in that postcode addresses applied to the mailings are recorded before the sorting process to give route order sorting, on the basis of the recorded postcodes it is determined which address points have mail and, on arranging the address points, those address points for which there is not at least one mailing are suppressed. The invention further relates to a device suitable for both sorting mail by address and also for route order sorting of mail. The method and device are particularly suitable or the sorting of large and oversize letters.

The invention relates to a method for sorting mail with which the mailpieces are sorted in a sorting process comprising at least two sorting passes according to a delivery point sequence of at least one delivery route encompassing several delivery points, for which purpose the mailpieces are fed into a sorting device that has a plurality of outputs at each of which a container is positioned to receive the mailpieces, the mailpieces are discharged into the containers at the outputs in a first sorting pass, said containers being associated with a delivery address applied onto the mailpieces, and the mailpieces in the containers are returned to the feeder in order to undergo at least one additional sorting pass.

The invention also relates to a device that is suitable to carry out the method.

It is a known procedure to sort mailpieces by means of so-called multi-pass methods according to the delivery point sequence of delivery routes, whereby the sorting takes place in several sorting procedures that are commonly referred to as passes.

In this process, for the first pass, the delivery points of the delivery routes are associated in a certain way with outputs of a sorting device. During the first pass, on the basis of the delivery address that has been applied onto the mailpieces, they are then collected at the outputs associated with the delivery addresses.

For the subsequent passes, associations are made once again between the delivery points and the outputs of the sorting device, a process in which the delivery points that were associated with a single output in a preceding pass are distributed among all of the outputs in a suitable manner.

In this context, for purposes of arranging the mailpieces in the prescribed sequence, the mailpieces are conveyed to the sorting device for a pass through the sorting device in a prescribed sequence arising from the order of the outputs at which the mailpieces were collected during a preceding pass.

In this manner, in the last scheduled pass, mailpieces can be collected at the outputs in the sequence in which they are delivered to the delivery points by a mail carrier on his delivery route.

As a rule, a two-pass method is used for the sequence sorting in which mailpieces can be sorted for a number of delivery points that corresponds to the squared number of outputs of the sorting device.

In order to attain the highest possible utilization of the capacity of the sorting device, the delivery point sequence sorting normally entails sorting mailpieces for several individual delivery routes and, in the case of standard and compact letters, the mailpieces are discharged in the form of a combined stack by the sorting device.

U.S. Pat. No. 6,943,312 or German patent specification DE 100 39 419 C1 disclose the use of separator cards or of stickers applied onto the mailpieces in order to mark the boundaries of sections of the combined stack containing mailpieces intended for a delivery route.

In comparison to standard and compact letters, the sorting and especially the delivery point sequence sorting of large and oversize letters are considerably more complicated since, owing to the size of the letters and especially owing to the very different formats of the mailpieces, it is not possible for the sorting device to create essentially homogeneous stacks of mailpieces having the same format.

For example, international patent application WO 02/090006 describes a sorting device for large and oversize letters that can also be used for delivery point sequencing.

This prior-art sorting device comprises a letter-sorting machine with which letters are fed in at several feeders and then discharged into containers at outputs. In order to carry out a delivery point sequencing, the machine has a storage facility where containers that have been filled in one pass are received and sorted so that they can be conveyed in the prescribed sequence to the feeders for the next pass.

In this process, a container that has been completely filled during one pass is conveyed from the output into the storage facility while an empty container into which more mailpieces are discharged whose delivery address is associated with this output is conveyed to said output.

After completion of one pass, the filled containers of each output are collected in the storage facility and this collection is then arranged in the order of the outputs.

Like the delivery point sequencing of standard and compact letters, the delivery point sequencing of large and oversize letters is carried out on the basis of a sorting plan in which, for each pass, a sorting matrix is formed by means of which an output is associated with each delivery point that is dealt with during the sorting procedure.

Especially in the case of the delivery point sequencing of large and oversize letters, in order to process the mailpieces as quickly and cost-effectively as possible, preference is given to two-pass methods entailing only two passes through the machine instead of methods involving several passes through the machine.

In order to be able to deal with a sufficient number of delivery points, there is a need for a very large number of outputs so that the sorting device requires a considerable amount of space.

Often, the requisite size of the sorting machine exceeds the space available in the sorting centers of a postal service provider.

Moreover, in order to prepare the delivery point sequencing of mailpieces, they have to be sorted according to their destinations so that only those mailpieces that are to be delivered on the delivery routes for which the sorting process is being performed are conveyed to a sorting process for delivery point sequencing.

Normally, a first sorting machine configured to sort according to destinations is employed for this purpose. The mailpieces sorted by this machine are then conveyed to the device that performs the delivery point sequencing.

Therefore, one sorting assembly for delivery point sequencing consists of at least two sorting machines, as a result of which the machine-based sorting is very un-economical. Consequently, the delivery point sequencing is usually done manually.

The invention is based on the objective of eliminating the above-mentioned draw-backs of the state of the art and of allowing a delivery point sequencing of mailpieces that can be performed especially with sorting machines that are compact and designed as simply as possible.

This objective is achieved in accordance with the invention by means of a method according to Claim 1.

Advantageous refinements of the method are the subject matter of the subordinate Claims 2 to 18.

In accordance with the invention, this objective is also achieved by a device according to Claim 19.

Advantageous refinements of the device are the subject matter of the subordinate Claims 20 to 26.

In particular, the invention proposes carrying out a method, as described in the generic part of claim 1, in such a way that the delivery addresses applied onto the mailpieces are detected, that the detected delivery addresses are used to ascertain for which delivery points mailpieces are present and that, during the association between the outputs and the delivery points, the delivery points for which there is not at least one mailpiece present are suppressed.

The method entails the advantage that only the delivery points for which at least one mailpiece is present can be associated with an output. In this manner, especially when it comes to sorting large and oversize letters which are not present on a daily basis for most of the delivery points, it becomes possible to save a substantial number of outputs for the sorting involving a prescribed number of delivery routes.

As a consequence, sorting devices that require considerably less space can be used for the delivery point sequencing.

Moreover, the transportation distances for the mailpieces are shorter in a smaller sorting device, as a result of which the processing time needed for the sorting is reduced.

Therefore, other advantages of the invention are the time gain and greater availability of a sorting device since each additional output constitutes an additional potential source of malfunctions of the device.

In advantageous embodiments of the method, no more mailpieces are discharged at an output once the container positioned there has become completely full.

Then, only one container from each output has to be conveyed to the feeder of the sorting device for the second sorting pass and a complex facility to store and sort the containers can be dispensed with.

The containers can be transported in a simple manner to the feeder in a sequence that corresponds to the physical arrangement of the outputs.

In an advantageous embodiment, mailpieces having a delivery address that is associated with a certain output are discharged into an overflow means when the container at that particular output is full.

Filled containers at the output associated with the overflow means are transported out of the area of the sorting device and are no longer dealt with during the sorting process.

In a preferred alternative embodiment of the method, the number of mailpieces on hand for each delivery point is determined before the sorting process is started.

In this manner, the sorting device can be fed with only those mailpieces that can, be accommodated by the containers, so that the overflow means can be dispensed with.

Preferably, the mailpieces that are not dealt with in a first sorting process because either they were discharged into the overflow means or because they were not fed into the sorting device, are sorted in a subsequent sorting process according to the delivery point sequence.

The approach of sorting several partial volumes of the total volume of mailpieces within the scope of several sorting processes especially takes into account the logistical circumstances during the sorting of mailpieces.

Thus, the mailpieces that are to be sorted according to the delivery point sequence are not all dropped off at a sorting center of a postal service provider at the same time, but rather this is spread over a certain period of time.

As a consequence, mailpieces that were not dealt with in a first sorting process are sorted according to the delivery point sequence together with the mailpieces that were dropped off after the beginning of the first sorting process.

In comparison to a method in which all of the mailpieces are sorted within the scope of one sorting process that is started after the last mailpieces have been received, sorting the mailpieces in several partial volumes provides an altogether larger window of time within the period available for the delivery point sequencing.

The partial volumes of mailpieces generated for a delivery route that were sorted according to the delivery point sequence are preferably combined by another sorting procedure to form a total volume of mailpieces sorted according to the delivery point sequence.

This is done either in another automated sorting process or else manually, for example, by the mail carrier.

In order to further improve the efficiency during the sorting procedure, in a preferred embodiment of the method, it is proposed that delivery points for several delivery routes be associated with one output.

As a result, optimal filling of the containers can be achieved during the sorting procedure, thereby largely avoiding partially filled containers. This measure makes it possible to further increase the number of delivery routes that are handled during the sorting with a given number of outputs.

In order to be able to easily separate the mailpieces intended for different delivery routes, during the sorting, a separator card is advantageously inserted into the containers that hold mailpieces for several delivery routes after the last mailpiece belonging to a given delivery route.

The sorting of the mailpieces according to the delivery point sequence is preferably carried out in a distribution center located in the vicinity of the destination of the mailpieces.

In a particularly preferred embodiment of the method, however, the delivery addresses on the mailpieces are detected at the location where the mailpieces are mailed.

During the detection, an identification code is advantageously applied onto the mailpieces, said identification code being unambiguously associated with the mailpiece.

This association is advantageously stored in a unit that is accessed when the mailpieces are sorted. In a preferred embodiment of the method, the mailpieces are discharged at the outputs of the sorting device as a function of their identification code.

Preferably, the dimensions and/or weight of the mailpieces are also detected during the sorting. After the dimensions and/or the weight have been checked, those mailpieces whose format and/or weight does not allow them to be reliably sorted are ejected from the mail stream.

Moreover, postage indicia located on the mailpieces are advantageously checked. Mailpieces without a valid postage indicium are likewise ejected from the mail stream.

The device according to the invention for sorting mailpieces comprises at least one feeder for feeding in mailpieces, at least one identification zone for detecting delivery addresses present on the mailpieces and containing at least a destination and a delivery point, and for applying onto the mailpieces identification codes that are unambiguously associated with said mailpieces, a means to store the association between the mailpieces and the identification code, a plurality of outputs at which the mailpieces are discharged into containers as a function of the identification code, taking into consideration the association between the identification code and at least one conveying means to transport the containers from the outputs to the feeder.

The device is particularly characterized in that it has an activation means to activate a first and a second operating state of the device whereby, in the first operating state, an association means associates at least one destination with each output, then the mailpieces are discharged at the appropriate outputs as a function of the association between the identification code and the destination of the mailpieces, and filled containers are transported away from the outputs and out of the area of the device and, in the second operating state, for a first sorting pass of a sorting process for delivery point sequencing, the association means associates a delivery point with each output, then the mailpieces are discharged at the appropriate outputs as a function of the association between the identification codes and the delivery points, the conveying means transports the filled containers from the outputs to the feeder and, for a second sorting pass of the sorting process for delivery point sequencing, the association means associates a delivery point with each output, and the mailpieces are discharged at the appropriate outputs as a function of the association between the identification codes and the delivery points.

The device has the advantage that it can be employed for sorting mailpieces according to the destination as well as for the delivery point sequencing.

The term destination can refer to a destination region, a delivery district group and/or an individual delivery district and, in particular, it refers to the sorting depth necessary to prepare for delivery point sequencing.

Therefore, the entire sorting of the mailpieces can be done by a single machine that can be flexibly operated in two operating states.

In an especially preferred embodiment of the device, in the second operating state, the association means, according to the method according to the invention, suppresses the delivery points for which no mailpieces are present when the association between the outputs and the delivery points is carried out.

The device preferably also comprises a means to drop a separator card into the containers. This is particularly advantageous if, during the delivery point sequencing in the second operating state, mailpieces intended for several delivery districts are placed into one single container. The mailpieces for different delivery districts can then be separated from each other by the separator card.

In another preferred embodiment, at least one output is associated with an overflow function. This is where the mailpieces are discharged when the container at the output that is associated with the delivery address of the mailpieces is already full.

It is also advantageous to equip the device with a means to detect the identification attributes of the containers and with a control unit that effectuates the conveyance of the containers to the feeders as a function of the identification attributes.

In this manner, the sorting device can be fed with only those mailpieces that can be accommodated by the containers and the overflow means can be dispensed with.

In this context, it is particularly practical for the device to likewise have a means to associate the identification attributes with the mailpieces held in the containers.

The identification attributes are preferably identification codes that are applied onto the containers.

It is likewise advantageous if, in the area of the outputs, the device has a filling level control mechanism to ascertain the filling level in the containers arranged at the outputs.

As a result, the sorting device can especially be controlled in such a manner that no more mailpieces are discharged at an output where the container is already completely full, and these mailpieces are then conveyed, for instance, to an output that is associated with an overflow function.

Additional advantages and practical refinements of the invention ensue from the subordinate claims and from the presentation below of preferred embodiments making reference to the figures.

The figures show the following:

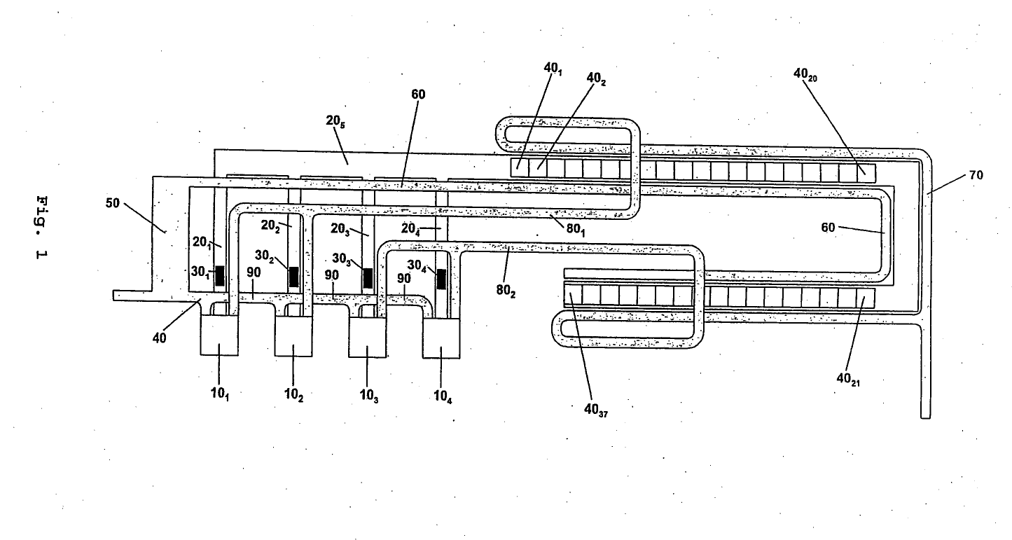

FIG. 1 a schematic depiction of a device to sort large and oversize letters, in a top view;

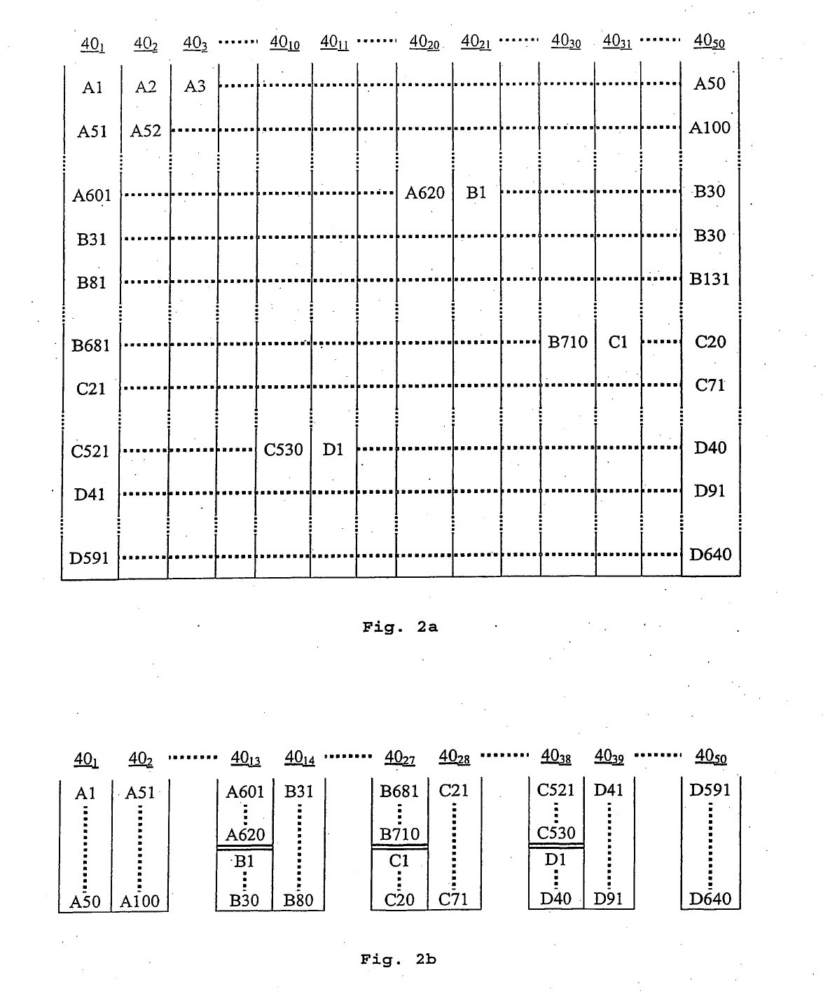

FIG. 2a a sorting matrix for the first sorting pass; and

FIG. 2b a sorting matrix for the second sorting pass.

The sorting of large letters (GBf) and oversize letters (MBf) measuring, respectively, 353 mm×250 mm×20 mm and 353 mm×250 mm×50 mm at the maximum, and weighing, respectively, 500 grams or 1000 grams at the maximum, will be presented as an example below.

The invention, however, is by no means restricted to the sorting of large letters and oversize letters having these formats. Fundamentally speaking, with slight adaptations, the method according to the invention can be used to sort mailpieces having any desired formats or weights.

Mailpieces can be dropped off by a customer of a postal service provider at a sending location, for example, at branch offices of the postal service provider, in a mailbox at the sending location or, in the case of senders who deal with large volumes of mail, directly at a sorting center of the postal service provider.

The mailpieces dropped off at the branch offices and in the mailboxes are collected by the postal service provider and conveyed to a sorting center in the region where the mailpieces are mailed. At this outbound mail center (BZA), the mailpieces are sorted according to their destination regions and especially according to the inbound mail centers (BZE) located in the areas of the destination regions of the mailpieces.

Following the sorting in the outbound mail center, the mailpieces are transported to the inbound mail center, where they undergo a fine sorting that, if possible, encompasses sorting the mailpieces according to the delivery point sequence of the delivery routes in the area of the inbound mail center. Finally, the mailpieces are delivered by a mail carrier or else placed into a post office box. As a rule, the mailpieces delivered to a post office box are not sorted according to the delivery point sequence of a delivery route.

The sorting devices in the sorting centers are configured in such a way that they allow sorting in the outbound mail centers as well as in the inbound mail centers. In particular, they can be operated in two operating states, one of which allows sorting according to destinations and the other of which allows a delivery point sequencing.

For the sorting in the outbound mail center at the drop-off place, the mailpieces are conveyed to the sorting center starting at about mid-day. The feeding of the mailpieces is staggered in a large number of partial volumes that are sorted according to their destination in the outbound mail center. This can encompass sorting according to destination regions or according to delivery district groups encompassed by the destination region.

In a processing step that precedes the sorting procedure, the dropped-off mailpieces are first segregated and it is checked whether the dropped-off mailpieces can be sorted by machine or whether they have to be processed manually due to their special format, special wrapping or similar properties.

The mailpieces that are suitable for machine sorting are conveyed to a letter-sorting machine (FSQM—flat sorting and sequencing machine) for large letters and oversize letters, as is schematically shown in FIG. 1. A sorting center has one or more FSQMs.

FIG. 1 shows by way of example four feeders 10₁ to 10₄ into which the mailpieces are fed either manually or by machine. In the case of the machine feed, the mailpieces are transported, preferably in containers, by a conveying means (not shown in the figure) to the feeders, where they are tipped over. The conveying means can be configured, for instance, as an arrangement of roller conveyors.

The containers emptied at the feeders 10₁ to 10₄ are transported by a conveying means 90 to a storage facility 50 for empty containers.

Conveying means 20₁ to 20₅, which are integrated into the FSQM, first convey the mailpieces to the identification zones 30₁ to 30₄ that are arranged on the conveying means 20₁ to 20₄. However, it would likewise be conceivable to provide only one single identification zone on the conveying means 20₅ but this modality is less preferred because it impairs the processing speed.

The conveying means 20₁ to 20₅ are configured, for example, as continuous conveyor belts.

The identification zones 30₁ to 30₄ each have an address reader which detects and interprets the delivery data and at least the delivery address that are present on the mailpieces.

The detected delivery data is stored in a data record containing data accompanying the mailpiece and especially comprising the name and address of the recipient of the mailpiece. The address consists of a street name, house number, postal code and city.

The detection of the delivery address likewise entails checking whether the designated city matches the indicated postal code. If it is found that the postal code does not match the postal code of the designated city, then the destination region is ascertained on the basis of the designated city and the postal code is ignored. This approach is taken because it is less likely that a sender will have written the wrong city name on the mailpieces than that he will have written an incorrect postal code.

An OCR (optical character recognition) unit is employed for the machine recognition of the delivery and sender addresses. If this unit cannot recognize the delivery address, then the delivery address is encoded by means of video coding. In this process, a scanner is used to record an image of the mailpiece surface bearing the delivery address and this image is displayed to video encoding personnel, who then recognize the delivery address and enter it using an input device.

Depending on the sorting depth defined for the sorting in the outbound mail center, it is then necessary for the first two digits or else all of the digits of the postal code to be recognized and entered by the video encoding personnel. The first two digits of the postal code indicate the destination region of the mailpiece and the delivery district group is encoded in the remaining digits.

The other components of the delivery address, which do not have to be known in order for the sorting to be carried out in the outbound mail center, can be subsequently encoded during the transportation of the mailpieces from the outbound mail center to the inbound mail center. This is referred to as the post-encoding of the addresses.

This measure makes it possible to carry out the sorting in the outbound mail center very quickly and it also contributes to attaining a considerable sorting depth.

At the identification zones 30₁ to 30₄, the mailpieces are also provided with an identification code, preferably a barcode, with which the data record containing the data accompanying the mailpiece is associated, thus allowing an unambiguous identification of the mailpieces.

In this context, the mailpieces undergo gloss scanning in order to ascertain the reflectance of the mailpieces. On the basis of the reflectance, it is determined whether the surface of the mailpieces allows an identification code to be printed directly onto the mailpieces or whether a label has to first be applied onto the mailpieces using a label dispenser, after which the code can be printed onto the label. The latter approach is necessary, for instance, for mailpieces that have a plastic wrapper.

A means to detect the identification code is likewise provided at each identification zone 30₁ to 30₄. These readers make it possible, on the one hand, to check the legibility of the identification code that has been applied onto the mailpieces. On the other hand, the readers allow the identification of the mailpieces and, on the basis of the reading results, the mailpieces can be associated with an output 40₁ to 40_{N} of the FSQM, so that they can be discharged there.

In this context, each identification zone 30₁ to 30₄ is provided with two readers to detect the identification code, one of these readers being arranged upstream from the OCR unit. This makes it possible to check whether the mailpiece has already been provided with an identification code and can be processed on the basis of this identification code, or whether it is still necessary to detect the mailpiece data.

The identification zones 30₁ to 30₄ can also encompass a means to determine the format of the mailpieces, including their length, width and height as well as their weight. The detected format of the mailpiece can be likewise added to the data record containing the data that accompanies the mailpiece.

If the format of a mailpiece exceeds the dimensions specified for large letters and oversize letters, this mailpiece is conveyed to a discharge site and removed from the area of the sorting machine since, with excessively large formats, it cannot be reliably ensured that the mailpiece can be properly discharged into the container provided for this purpose. The discharge site is located in the area of the identification zones 30₁ to 30₄ and it is not shown in FIG. 1.

The identification zones 30₁ to 30₄ can likewise comprise detectors that serve to check the postage on the mailpieces. The requisite amount of postage is especially determined on the basis of the format of the mailpiece.

In order to sort the mailpieces in the outbound mail center, the destination contained in the delivery address of the mailpieces is evaluated. As a rule, this is done as a function of the postal code, whose first two digits indicate the destination region of the mailpiece and whose remaining digits indicate especially the delivery district group of the mailpiece.

During the sorting in the outbound mail center, the sorting in the inbound mail center is prepared to the greatest extent possible. To this end, it is provided that the mailpieces in the outbound mail center are already sorted according to the delivery point sequencing processes in the inbound mail center, so that the mailpieces can be fed there directly into the first pass of a process for delivery point sequencing in the delivery order on the delivery routes in the delivery districts of the delivery district groups.

During sorting according to delivery point sequencing processes, one or more delivery district groups are associated with the outputs 40₁ to 40_{N-m} of the FSQM and the mailpieces are discharged in accordance with their postal codes at the corresponding outputs 40₁ to 40_{N-m} into containers that are positioned at the outputs 40_{N-m}.

A number m of outputs 40_{N-m+1} to 40_{N} is associated with a reject function, that is to say, this is where mailpieces are discharged that could not be associated with the other outputs, for instance, because they did not have a legible delivery address, or that should not be associated with any outputs, for instance, because they did not have valid postage.

In the top view of the FSQM in FIG. 1, N=37 outputs are depicted by way of example. Typically, depending on the size of the sorting center, an FSQM has between N=200 and N=500, preferably between N=280 and N=400, outputs.

The containers to be positioned at the outputs 40₁ to 40_{N} are transported by a conveying means 60 that serves to convey empty containers from a storage facility 50 for empty containers to the outputs 40₁ to 40_{N} and positioned under the appertaining discharge mechanisms. The conveying means 60 is preferably configured as a roller conveyor.

The containers are provided with an identification code that allows an unambiguous identification of the containers. In this context, the identification code is permanently associated with a container and is preferably configured in the form of a barcode.

When a container enters the FSQM, the identification code is detected and stored together with information about the output at which it is filled. In order to detect the identification code, a container identification station equipped with a scanner to read in the codes is provided on the conveying means 60.

At the outputs 40₁ to 40_{N}, the mailpieces are directed into a chute through which they reach the container located under the discharge mechanisms. Optionally, the mailpieces can be discharged directly from the carrier of the sorter without the need for an additional chute.

The large letters and oversize letters are discharged in such a way that they are stacked lying horizontally on top of each other in the containers, whereby approximately 52 large letters and/or oversize letters can be accommodated in the containers.

The filling level of the containers can be determined by means of the filling-level indicator. Preferably, the filling level is determined on the basis of the number of mailpieces dropped in and on the basis of their thickness.

Moreover, a unit for monitoring the stack formation is provided in order to detect erroneously stacked mailpieces which, for instance, stick out over the edge of a container, and to generate a warning signal when a defective stack formation is detected.

The containers that have been completely filled during a given sorting pass during sorting in the outbound mail center are conveyed by a conveying means 70 that serves to remove full containers out of the area of the sorting device. This output is then provided with another empty container that is filled with more mailpieces that have to be discharged at this output.

Mailpieces of which only the first two digits of the postal code could be recognized in the outbound mail center, even though sorting according to delivery point sequencing processes is called for, are discharged at one of the outputs associated with a delivery district group in the destination region. In this manner, it is ensured that these mailpieces will be transported to their destination region.

The filled, regular containers, that is to say, the containers of the outputs which were not associated with a reject function, are taken to a commissioning area in the outbound mail center, where they are combined to form suitable commissioned groupings to be subsequently transported via the so-called main mail stream. In this main mail stream, the mailpieces are conveyed to their destination regions via the overnight airmail network and/or by truck and/or by other transportation means.

The volume of local mail destined for the outbound mail center itself, that is to say, the mailpieces for which the outbound mail center and the inbound mail center are identical, are stored in the commissioning area separately from the other mailpieces.

The mail received in the outbound mail center is sorted in the manner described above by approximately 9:00 p.m. After the sorting has been completed, the addresses that were not recognized during the sorting can be post-encoded at the video encoding stations. After the sorting, considerably more time can be dedicated to ascertaining a delivery address and/or sender address without causing any delay in the processing of the mailpieces.

The delivery addresses that are recognized during the post-encoding are added to the data record that was created for the mailpiece and that contains the data accompanying the mailpiece.

It is provided for the outbound mail center and the inbound mail center to be networked with each other and to exchange mailpiece information. This means, in particular, that the data that accompanies the mailpiece and that has been detected in an outbound mail center is made available for retrieval by devices in the in-bound mail center.

In this process, the data records are either stored in the area of a central server which can be accessed by all of the sorting centers, or else the data records are transmitted via remote data transfer from the outbound mail center to the appertaining inbound mail center where the mailpieces are further processed.

In the inbound mail center, the mailpieces are sorted again on the basis of these data records, and this especially encompasses a sorting of the mailpieces according to the delivery point sequence of the delivery routes in the delivery districts of the destination region.

For this reason, the association means that creates the association between the outputs of the FSQM and the delivery points for the delivery point sequencing of the mailpieces has the capability to access the data accompanying the mailpieces.

The same FSQMs that are used for the sorting in the outbound mail center are also employed for the delivery point sequencing. For purposes of automated delivery point sequencing, the FSQMs are equipped with additional conveying means 80 by means of which containers from the outputs 40₁ to 40_{N} can be transported to the feeders 10₁ to 10₄.

In order to be able to perform the delivery point sequencing, the appropriate operating state in which the sorting is carried out has to be selected for the FSQM.

In this context, a multi-pass method is employed for the delivery point sequencing. So that the mailpieces can be processed as quickly and cost-effectively as possible, preference is given to a two-pass method in which the mailpieces only pass through the FSQM twice. In comparison to a multi-pass method involving more than two sorting passes, this allows a particularly gentle processing of the mailpieces.

In order to carry out the two-pass method, sorting plans are drawn up in which the association between the outputs and the delivery points is laid down for both passes.

To this end, in the applicable operating state, the sorting plans are loaded into the association means and then implemented by the latter.

The sorting plans can be rendered visible in the form of sorting matrices such as those shown, for example, in FIGS. 2a and 2b.

For purposes of elucidating the principle upon which the sorting method is based, the example is shown of a delivery point sequencing for four delivery districts A to D employing N=50 outputs of an FSQM. In the example, the delivery route A should encompass 620 delivery points, delivery route B should have 710 delivery points, delivery route C should have 530 delivery points and delivery route D should have 640 delivery points.

The delivery points are designated with the letters of the corresponding delivery route and with a number. The numbering corresponds to the sequence in which the delivery points are reached by the mail carrier on his delivery route. As a rule, this does not match the sequence of the house numbers on a street.

The sorting matrix depicted in FIG. 2a shows the association between the outputs 40₁ to 40₅₀ and the delivery points for the first pass of the delivery point sequencing, whereby the numbers of the outputs 40₁ to 40₅₀ are indicated in the top line of the depiction.

According to the sorting matrix shown, the delivery points A1, A51, A101, etc., to A601 of the delivery route A are associated with the output 40₁, while the delivery points A2, A52, A102, etc., to A602 are associated with the output 40₂. The association between the other outputs and delivery points is done in a corresponding manner.

Generally speaking, the association at N outputs 40₁ to 40_{N} is done in such a way that the delivery points with the numbers a, for which a mod N=k applies, are associated with the output 40ₖ wherein 1≦k<N. The delivery points a, for which a mod N=0, are associated with the output 40_{N}.

For the delivery route B, the association between the outputs 40₁ to 40₅₀ is done as if this delivery route were a continuation of the delivery route A.

In a corresponding manner, the delivery point B1 is associated with the output 40₂₁, the delivery point B2 is associated with the output 40₂₂, etc., up to the last delivery point B710 of this delivery route, which is associated with the output 40₃₀.

The association of the delivery points of the delivery routes C and D is done in an analogous manner, likewise as if these delivery routes were a continuation of the preceding delivery routes.

Therefore, the sorting matrix is set up here as if the delivery routes A to D were combined into one large delivery route.

This avoids partially filled containers that would be created if a single output were not allocated to delivery points of different delivery routes. This becomes particularly clear in conjunction with the sorting matrix for the second pass.

During the first pass, the mailpieces reach the FSQM in a completely unarranged fashion so that, although a container that has been filled at an output in accordance with the sorting plan only contains mailpieces for certain prescribed delivery points, these mailpieces are stacked in the container in a random order.

Consequently, in the case of the two-pass method, it is provided that the delivery points that were associated with a single output in the first pass are distributed in the second pass among all of the outputs, without the occurrence of double allocations in this process.

Thus, with a total number of N outputs, a maximum of N delivery points can be associated with one output, so that at the maximum N² delivery points can be dealt with during the sorting.

If a prescribed order is observed when the containers filled during the first pass are readied for the second pass, then each delivery point is unambiguously determined at a defined position inside a container filled during the second pass in such a way that the mailpieces for a certain first delivery point come to lie at the bottom, then the mailpieces for a second delivery point come to lie on top of these, and so on.

FIG. 2b shows the sorting matrix for the second pass in the example on hand.

According to this matrix, during the second sorting pass, the delivery points A1 to A50 are associated with the output 40₁, the delivery points A51 to A100 are associated with the output 40₂, etc., until finally the delivery points A601 to A620 are associated with the output 40₁₃.

During the second sorting pass, the delivery route B, once again, is treated as if it were a continuation of the delivery route A. In this manner, the delivery points B1 to B30 are likewise associated with the output 40₁₃, then 50 delivery points B31 to B80 are associated with the output 40₁₄, the delivery points B81 to B130 are associated with the output 40₁₅, etc., until the delivery points B681 to B710 are associated with the output 40₂₇.

The delivery routes C and D then are likewise treated as if they were continuations of the preceding delivery routes. Accordingly, the association of their delivery points with the outputs is done as shown in FIG. 2b.

When the containers for the second pass are fed to the FSQM in a descending order of the outputs, that is to say, first the container that has been filled at the output 40₅₀, then the container that has been filled at the output 40₄₉, and so on, until the container that was filled at the output 40₁ is fed in as the last container, the result is the stacks in the containers as depicted in FIG. 2b. In other words, the mailpieces for the delivery point A1 are lying at the very bottom in the container at the output 40₁ and the mailpieces for the delivery point A2 are lying on top of these, and so on.

After the second pass, mailpieces for two different districts or delivery routes are located in the containers at the outputs 40₁₃, 40₂₇ and 40₃₈.

During a processing step that follows the sorting, these mailpieces are separated from each other manually. A particularly simple separation is achieved in that, during the second pass, a separator card is inserted into the containers between the mailpieces intended for different delivery districts. This separator card is indicated in FIG. 2b by a double line.

It can be likewise provided in the sorting plan for the second pass that the mailpieces for the delivery point A1 are associated with the container at the output 40₅₉ and are lying there at the very top, with the mailpieces for the delivery point A2 below these, and so on, down to the mailpieces for the delivery point A50. The mailpieces for the delivery point A51 are arranged at the very top in the container at the output 40₄₉, the mailpieces for the delivery point A52 below these, and so on.

This alternative sorting plan, which has proven to be particularly convenient in actual practice, can be depicted as a mirror image of the sorting plan shown in FIG. 2b.

The sorting plans described above deal with all of the delivery points of the individual delivery routes. As a rule, however, large letter and oversize letters are not present at every delivery point every day.

Therefore, it is provided for the sorting plans to only deal with delivery points to which mailpieces are actually supposed to be delivered, whereby these delivery points can be identified on the basis of the data that accompanies the mailpieces and that was detected during the sorting in the outbound mail center or in the inbound mail center.

Consequently, no rigid sorting plan serves as the basis for the delivery point sequencing in the inbound mail center but rather, the sorting plans for each sorting process are adapted to the mail volume on a case-to-case basis.

This means, for instance, that the first delivery point of the delivery route A for which at least one mailpiece is present, the 51^{st} delivery point of this delivery route for which at least one mailpiece is present, the 101^{st} delivery point of this delivery route for which at least one mailpieces is present, and so on, are associated with the output 40₁ for the first pass. The first delivery point of the delivery route B for which one mailpiece is present is correspondingly associated with the output that follows the output with which the last delivery point of the delivery route A for which at least one mailpiece is present is associated.

The sorting matrix for the second pass can be set up on the basis of a corresponding approach.

This makes it possible to save outputs during the delivery point sequencing of large letters and oversize letters for the sorting of a prescribed number of delivery routes. Conversely, mailpieces for a larger number of delivery routes can be sorted with the same number of outputs.

In order to sort all of the mailpieces for a delivery district according to the delivery point sequence, the sorting process has to be carried out with all of the mailpieces for this delivery district, so that it can only be started after the last mailpiece for this delivery district had been received.

However, since the mailpieces reach the inbound mail center via the main mail stream by about 4:30 a.m. and the delivery point sequencing has to have been completed by about 7:00 a.m. at the latest, so that the mailpieces can be delivered on the same day, as a rule there is not enough time to perform the delivery point sequencing of all of the mailpieces.

For this reason, it is provided that the mailpieces that arrive at the inbound mail center in staggered batches are sorted in several consecutive sorting processes according to the delivery point sequence. Even though this process gives rise to several partial volumes of mailpieces for a delivery district that have to be sorted according to the delivery point sequence and that then have to be combined to form a combined volume, this can be done in a simple and quick manner by means of another pass through the machine or else manually by the mail carrier in a delivery depot.

Moreover, the delivery point sequencing entails the problem that the containers at the outputs 40₁ to 40_{N} can only accommodate a limited number of mailpieces. If, like in the example shown, 50 delivery points are associated with the outputs and if the containers have a holding capacity of approximately 52 mailpieces, then the containers can only hold an average of approximately 1.04 mailpieces for each delivery point.

Particularly when the sorting plan only takes into account the delivery points for which mailpieces are actually present, then the average number of mailpieces for each delivery point is usually larger.

For this reason, the containers filled during one pass are normally taken to a storage facility and another empty container is conveyed to the output. After the first pass, the containers then have to be sorted so that they can be conveyed to the FSQM in the correct order for the second pass.

In this context, however, a very complex storage and sorting facility has to be provided for the containers, requiring a considerable amount of space and constituting an additional source of potential operating malfunctions of the FSQM.

For this reason, it is provided that every sorting process for the delivery point sequencing sorts only those mailpieces that can be accommodated in the containers at the outputs 40₁ to 40_{N}.

The remaining mailpieces are either discharged at a prescribed output which is associated with an overflow function or else they are not even placed into the FSQM to begin with. The latter approach is possible due to the data accompanying the mailpieces that was acquired during the sorting in the outbound mail center.

The mailpieces that were not dealt with during one sorting process are then reserved for the next sorting process involving the next partial volume of mailpieces.

Therefore, the delivery point sequencing of the mailpieces in several partial volumes not only translates into a better utilization of the time available for the sorting but also entails the advantage that a sorting procedure can be carried out in which only one container has to be filled at each output 40₁ to 40_{N}, thus dispensing with the need for complex storage facilities for the containers.

If there are many mailpieces for one given delivery point in a partial volume of mailpieces that are to be sorted in a sorting process, another dynamic adaptation of the sorting plan is provided:

In order to increase the number of mailpieces for one single delivery point that can be sorted in one sorting process, the delivery points that are associated with a single output in accordance with the above-mentioned concept are distributed among several outputs arranged next to each other.

Since the number of large letters and oversize letters is very large only for very few delivery points, the number of outputs consequently only has to be increased slightly.

On the basis of the measures described above, the mailpieces are sorted in the in-bound mail center in the following manner:

The mailpieces are delivered to the inbound mail center in several partial volumes within a certain time span. If all of the mailpieces were to be sorted in a sorting process according to the delivery point sequence, the sorting could only start after the last mailpiece had been received. However, this is not possible because not enough time is left to sort all of the mailpieces after the last mailpiece has been received.

This is why several partial volumes of the incoming mailpieces are sorted according to the delivery point sequence. The result is that several stacks that each have to be sorted according to the delivery point sequence are created for one delivery district and these partial volumes have to be combined in a subsequent work step to form a combined stack. This, however, can be easily done either manually or by automated means.

Thus, the partial stacks can be combined, for instance, by a mail carrier prior to his delivery route. This is preferably done at the appropriate delivery depots which are then supplied with the partial stacks from the inbound mail center.

Moreover, the sorting of several partial volumes also makes it possible that only one container has to be filled at each output during a given sorting process. Once the container is completely full, the mailpieces bearing delivery addresses that are associated with this output are discharged into an overflow means and processed within the scope of the next sorting process.

An alternative embodiment dispenses with this overflow means and, when the sorting plans are being calculated, individual mailpieces are already associated with the outputs, so that optimal filling of the containers is attained. Then, during the sorting procedure, only mailpieces that are already associated with the outputs are placed into the FSQM, so that there is no need for an overflow means.

This makes it possible to dispense with the complex container storage facility for the FSQM.

The concept presented here for the delivery point sequencing gives rise to the following procedures in the inbound mail center:

The large letters and oversize letters sorted in the outbound mail center according to delivery district groups are delivered to the inbound mail center. In this context, the arrivals at the inbound mail center are staggered over time; the last mailpieces that are to be delivered on the same day should be received at the inbound mail center at the latest by about 4:30 a.m.

When the containers arrive at the inbound mail center, the identification codes of the containers are detected and transmitted to a computing unit. On the basis of the codes, it can be ascertained which mailpieces are present in the containers that have already arrived.

The local mailpieces from the sorting center itself are then already at hand.

The sorting plans are drawn up before the mailpieces undergo the delivery point sequencing in the inbound mail center. This is done on the basis of the information about the mailpieces already received at the inbound mail center or else on the basis of the information made available by the outbound mail center. Since the conveying routines and especially their duration are known, it can be ascertained when the mailpieces are going to arrive at the designated inbound mail center after leaving the outbound mail center.

For purposes of drawing up the sorting plans, the computing unit of the inbound mail center can also access data about the tracking of a mailpiece if such data tracking is performed.

When the sorting plans are being drawn up, the partial volumes of mailpieces that have to be sorted in the individual sorting processes according to the delivery point sequence are defined. If the planning is made exclusively on the basis of the information about the mailpieces received at the inbound mail center, then the sorting plan for a given sorting process is drawn up taking into consideration the mailpieces that are present at the inbound mail center by a certain point in time.

It is provided for the first sorting process for the delivery point sequencing to start at about 10:00 p.m. In particular, during the first sorting process, the local mailpieces from the outbound mail center itself are taken into consideration for the same region. The point in time for starting the process, however, is selected in such a way that the number of mailpieces already present is large enough to completely utilize the capacity of the sorting center.

A sorting center of a typical size has at least two FSQMs, each with 280 outputs. For purposes of the delivery point sequencing, the FSQMs are partitioned, that is to say, divided into several sections in which a delivery point sequencing is carried out independently. A typical partitioning, for instance, comprises four partitions, each with 70 outputs.

One of the outputs of each partition fulfills a reject function. Mailpieces that do not have valid addresses or that have been misdirected are discharged at this output.

Moreover, this output or another output can serve as the overflow means where mailpieces that could not be dealt with in one pass are discharged since the containers at the outputs where they are to be discharged in accordance with the sorting plan are already completely full.

However, since it is provided that only the mailpieces that can be actually sorted are placed into the FSQM in each sorting process, the overflow means will usually be dispensed with.

As elaborated upon above, the delivery points of the delivery routes dealt with during the sorting are associated with the other outputs of each partition.

When the sorting plans are drawn up, it is preferable to strive for a 90% filling level of the containers arranged at the outputs so that, based on the container's holding capacity of 52 mailpieces, this corresponds to a filling of 47 mailpieces. Therefore, approximately 47·69=3243 large letters and oversize letters can be sorted according to the delivery point sequence in one partition during a sorting process.

When the association is made between the outputs and the delivery points, the delivery points that are associated with a single output according to the diagram shown in FIG. 2a, as already described, are associated with several outputs located next to each other if an excessively large number of mailpieces is present for one of these delivery points.

Once at least the sorting plan for the first sorting process has been drawn up and all of the mailpieces to be sorted have reached the inbound mail center, the mailpieces are placed into the feeders of the FSQM for the delivery point sequencing.

The identification code applied onto the mailpieces is detected at the identification zones 30₁ to 30₄ of the FSQM and, on the basis of the delivery address of the mailpieces associated with this code—the address being ascertained on the basis of the data accompanying the mailpieces—the mailpieces are discharged at the output designated in the sorting plan for the first pass.

The association between the delivery addresses and the outputs is stored in the association means of the FSQM.

Once all of the mailpieces placed into the FSQM have been thus processed, for the second pass, the containers are conveyed in the prescribed sequence via the conveying means 80₁ and 80₂ to the feeders 10₁ to 10₄ of the FSQM, where they are emptied. The empty containers are transported by the conveying means 90 to the empty-container storage facility.

If two parallel zones are provided with outputs, as shown in FIG. 1, and if the containers from one zone are conveyed to different feeders than the containers from the other zone, then the mailpieces, from the one zone and the mailpieces from the other zone can be placed into the FSQM simultaneously. A prerequisite for this, however, is that the partitioning of the FSQM has to be selected in such a way that the containers of one zone belong to different partitions than the containers of the other zone.

The containers with the mailpieces that have been discharged at the output with which the reject function is associated are transported out of the area of the FSQM by means of the conveying means 70.

In the second pass, the identification codes of the mailpieces are once again detected at the identification zones 30₁ to 30₄ and the mailpieces are then discharged in accordance with their delivery address at the outputs that are associated with their delivery addresses in the sorting plan for the second pass.

During the second pass, as already elaborated upon, separator cards are inserted into the containers after the last mailpiece of a delivery route has been dropped into a container, so that it is easily possible to separate the mailpieces that belong to different delivery routes.

Once all of the mailpieces have been discharged in the second pass, the containers are transported out of the area of the FSQM by means of the conveying means 70 and collected in appropriate configurations, for example, in the commissioning area of the inbound mail center.

The subsequent sorting processes—during which additional partial volumes of the mailpieces that are to be sorted according to the delivery point sequence are sorted—are prepared and carried out in an analogous manner.

Typically, three to four individual sorting processes are needed in order to carry out the sorting according to the delivery point sequence of all of the large letters and oversize letters that have been received in an inbound mail center.

The processes are carried out staggered over time in such a way that, on the one hand, the last sorting process is completed in a timely fashion and, on the other hand, a sufficiently large number of mailpieces is on hand, especially for the earlier processes, so as to utilize the capacity of the FSQM to the greatest extent possible.

After all of the large letters and oversize letters received in an inbound mail center have been sorted according to the delivery point sequence in the manner described above, several partial volumes of mailpieces sorted according to the delivery point sequence are on hand for each delivery district.

These mailpieces are manually combined by the mail carrier to form a total volume of sorted mailpieces after they have been transported from the inbound mail center to the delivery depot.

However, it is likewise possible to perform an automated combination in the inbound mail center.

An alternative embodiment of the method differs from the one described above in that a lesser sorting depth is provided at the outbound mail center and then an additional sorting procedure is carried out at the inbound mail center for all incoming mailpieces.

In this context, the sorting at the outbound mail center is not carried out according to the delivery district groups, but rather according to the superordinated destination regions.

Finally, the mailpieces are transported to the inbound mail center of the destination region.

If it is not possible to take into account all of the delivery districts during a sorting process for the delivery point sequencing of the mailpieces, then the sorting according to delivery district groups or according to delivery groups is likewise necessary.

In this embodiment, however, this is carried out in the inbound mail center and, like the delivery point sequencing, it is done in several processes that are staggered over time.

Once enough mailpieces are on hand in the inbound mail center for the sorting with the best possible utilization of the capacity of the installation, the first sorting process for the sorting of the mailpieces according to their delivery districts or according to their delivery district groups is started.

If the mailpieces have not been provided with an identification code in the out-bound mail center, then the sorting is done in a manner analogous to what has already been described for the sorting in the outbound mail center, except that the post-encoding of the delivery addresses has to be dispensed with since not enough time is left for the post-encoding after the sorting process.

If an identification code was already applied onto the mailpieces in the outbound mail center, the sorting and especially the association of the mailpieces with the outputs are performed on the basis of the code and the appertaining data accompanying the mailpieces.

After the sorting process has been completed, the first sorting process for the delivery point sequencing is prepared and carried out in the same manner as described above.

This is once again followed by the second sorting process for the sorting according to delivery districts or delivery district groups as well as by the second sorting process for the delivery point sequencing, whereby the mailpieces to be especially handled are those that have arrived at in the inbound mail center during the first sorting process.

All in all, three or four sorting processes for the sorting according to delivery districts or delivery district groups are carried out one after the other in this manner so as to process the entire volume of large letters and oversize letters in an in-bound mail center.

This is done at the latest by about 7:00 a.m. in order to ensure the delivery of the mailpieces on the same day.

### LIST OF REFERENCE NUMERALS

10ₖ feeder (k=1, . . . , 4)
20ₗ conveying means (l=1, . . . , 5)
30ₘidentification zone (m=1, . . . , 4)
40ₙ output (N=1, . . . , N)
50 empty-container storage facility
60 conveying means to feed the empty containers
70 conveying means to remove the full containers
80ₚ conveying means to transport containers from the outputs to the feeders (p=1, 2)
90 conveying means to transport containers from the feeders to the empty-container storage facility
BZA outbound mail center
BZE inbound mail center
FSQM mail-sorting machine
GBf large letter
MBf oversize letter
N number of outputs

1. A method for sorting mail with which mailpieces are sorted in a sorting process comprising at least two sorting passes according to a delivery point sequence of at least one delivery route encompassing several delivery points, for which purpose
the mailpieces are placed into a sorting device that has a plurality of outputs at each of which a container is positioned to receive the mailpieces,
the mailpieces are discharged into the containers at the outputs in a first sorting pass, said containers being associated with a delivery address applied onto the mailpieces, and
the mailpieces in the containers are returned to the sorting device in order to undergo at least one additional sorting pass,
the method comprising
detecting the delivery addresses applied onto the mailpieces before the sorting process for the delivery point sequencing is carried out, using the detected delivery addresses to ascertain for which delivery points mailpieces are present and, during the association, suppressing the delivery points for which there is not at least one mailpiece present.

2. The method according to claim 1, comprising determining
the number of mailpieces for each delivery point.

3. The method according to claim 1, characterized in that, comprising feeding
the sorting device with only those mailpieces that can be accommodated by the containers that are present at the outputs.

4. The method according to claim 1, comprising sorting
the remaining mailpieces in at least one additional sorting process according to the delivery point sequence of at least one delivery route.

5. The method according to claim 1, comprising discharging
the mailpieces into an overflow container when the container at the output that is associated with the delivery address of the mailpieces is already full.

6. The method according to claim 1, comprising associating
delivery points for several delivery routes are associated with one output.

7. The method according to claim 1, comprising
during the sorting of the mailpieces according to the delivery point sequence of delivery routes, inserting a separator card into the containers after the last mailpiece belonging to a given delivery route.

8. The method according to claim 1, comprising detecting
the delivery address of the mailpieces is detected at a location where the mailpieces are mailed.

9. The method according to claim 1, comprising
sorting the mailpieces according to the delivery point sequence of delivery routes at a destination of the mailpieces.

10. The method according to claim 1, comprising sorting
the mailpieces according to the delivery point sequence in two sorting passes within the scope of a two-pass method.

11. The method according to claim 1, comprising applying
an identification code onto the mailpieces, said identification code being unambiguously associated with the mailpieces.

12. The method according to claim 1, comprising
during the delivery point sequencing, discharging the mailpieces at the outputs as a function of their identification code.

13. The method according to claim 1, comprising detecting at least one of
the dimensions and weight of the mailpieces.

14. The method according to claim 1, comprising checking
postage indicia located on the mailpieces.

15. The method according to claim 13 comprising ejecting
mailpieces that have excessive dimensions, excessive weight from the mail stream.

16. The method according to claim 1, comprising
during the delivery point sequencing, after the completion of one sorting pass, transporting the containers by at least one conveyor from the outputs to a feeder of the sorting device.

17. The method according to claim 16, comprising conveying
the containers to the sorting device in the order of the outputs.

18. The method according to claim 1, comprising emptying
the containers at least one feeder by a tipping mechanism or by tilting them.

19. A device for sorting mailpieces comprising,
at least one feeder for feeding in mailpieces,
at least one identification zone for detecting delivery addresses present on the mailpieces and containing at least a destination and a delivery point, and for applying onto the mailpieces identification codes that are unambiguously associated with said mailpieces,
a storage device to store the association between the mailpieces and the identification codes,
a plurality of outputs at which the mailpieces are discharged into containers as a function of the identification codes, and
at least one conveyor to transport the containers from the outputs to the feeder, and,
activator to activate a first and a second operating state whereby,
in the first operating state, an association device associates at least one destination with each output, then the mailpieces are discharged at the appropriate outputs as a function of the association between the identification code and the destination of the mailpieces, and filled containers are transported away from the outputs and out of the area of the device and,
in the second operating state, for a first sorting pass of a sorting process for delivery point sequencing, the association device associates a delivery point with each output (40₁, . . . , 40_{N}), then the mailpieces (GBf, MBf) are discharged at the appropriate outputs as a function of the association between the identification codes and the delivery points, the conveyor transports the filled containers from the outputs (40₁, . . . , 40_{N}) to the feeder and, for a second sorting pass of the sorting process for delivery point sequencing, the association device associates a delivery point with each output, and the mailpieces are discharged at the appropriate outputs as a function of the association between the identification codes and the delivery points.

20. The device according to claim 19, wherein
in the second operating state, during the association between the outputs and the delivery points, the association device suppresses the delivery points for which no mailpieces are present.

21. The device according to claim 19
comprising a means device to drop a separator card into the containers.

22. The device according to claim 19, comprising
at least one output associated with an overflow function, where mailpieces are discharged when the container at the output that is associated with the delivery address of the mailpieces is already full.

23. The device according to claim 19, comprising a device
to detect the identification attributes of the containers and a control unit that effectuates the conveyance of the containers to the feeders as a function of the identification attributes.

24. The device according to claim 23,
comprising a device to associate the identification attributes with the mailpieces held in the containers.

25. The device according to claim 23, wherein
the identification attributes applied onto the containers are identification codes.

26. The device according to claim 19, comprising
filling level control mechanism to ascertain the filling level in the containers arranged at the outputs.

27. The method according to claim 14, comprising ejecting mailpieces that are without valid postage from the mail stream.
